(19) United States
(12) Patent Application Publication
(10) Pub. No.: US 2026/0346429 A1
(43) Pub. Date: Nov. 5, 2026

(54) Perioperative Cobotic System with Sterilizable External Shell

(71) Applicant: Peritas AI Inc., Fort Lauderdale, FL (US)

(72) Inventor: Martin Roche, Fort Lauderdale, FL (US)

(73) Assignee: Peritas AI Inc., Fort Lauderdale, FL (US)

(21) Appl. No.: 19/432,460

(22) Filed: Dec. 24, 2025

Related U.S. Application Data
(63) Continuation-in-part of application No. 19/195,731, filed on Apr. 30, 2025.

(51) Int. Cl. B25J 9/00; B25J 5/00; B25J 9/16; B25J 19/00

(52) U.S. Cl. CPC B25J 9/0009; B25J 5/007; B25J 9/162; B25J 19/0087

(57) ABSTRACT

A perioperative cobotic system includes a robotic base and at least one articulated robotic arm enclosed within a modular external shell assembly configured for operation in sterile or semi-sterile surgical environments. The shell comprises multiple articulating segments formed of sterilization-compatible materials and shaped to maintain full range of motion while minimizing microbial harborage. The shell features smooth, non-porous surfaces, fluid-resistant articulation seals, and flush-mounted access panels to support in situ disinfection and prevent contamination. In various embodiments, the shell assembly supports reusable or disposable use cases and includes quick-release locking mechanisms for tool-free removal and replacement. Optional sterility monitoring components provide real-time feedback on contamination status and shell integrity. The shell is configured to allow operation within sterile zones without the need for additional draping and may include transparent regions to preserve visibility of internal indicators.

### CROSS-REFERENCE TO RELATED APPLICATIONS

This patent application is a continuation-in-part of US Patent Application Ser. No. 19/195,731 filed on Apr. 30, 2025, which claims the benefit of priority to U.S. Provisional Patent Application No. 63/640,524, filed on Apr. 30, 2024, the entirety of which is incorporated herein by reference.

### TECHNICAL FIELD

The present invention relates generally to surgical robotics and infection control systems, and more particularly to a perioperative cobotic system equipped with a sterilizable external shell designed to preserve sterility, prevent contamination, and enable safe operation within surgical environments.

### BACKGROUND

Maintaining sterility in the operating room is critical for minimizing the risk of surgical site infections and ensuring patient safety. Surgical equipment that enters or operates within the sterile field must comply with strict infection prevention protocols, typically requiring sterilization prior to use and careful handling to avoid contamination. Robotic systems introduced into the perioperative space, particularly those with articulated joints, internal actuators, and sensing hardware, pose unique challenges to these sterility requirements.

Existing cobotic platforms designed for perioperative use often rely on disposable drapes, custom sterile barriers, or manual cleaning processes to maintain compliance with sterile protocols. However, these approaches can be time-consuming, error-prone, or insufficiently robust for dynamic environments. Moreover, conventional robotic housings and surface geometries may include seams, fasteners, or crevices that trap particulates or harbor microbial contaminants, thereby complicating sterilization and increasing the risk of bioburden accumulation over repeated use.

Infection control challenges are further exacerbated by the need for repeated turnover between surgical cases. Cobotic systems that must be rapidly disinfected between procedures require surface designs and materials compatible with fast, effective sterilization techniques such as autoclaving, chemical wipes, ultraviolet-C (UV-C) exposure, or plasma-based methods. A lack of modularity and real-time feedback on sterility status further limits integration of robotic systems into the sterile workflow.

Therefore, there is a need for a cobotic system that integrates a purpose-built external shell designed to preserve sterility in surgical environments. Such a system should support modular replacement, withstand rigorous sterilization cycles, avoid microbial harborage, and provide sterility status indicators, all while enabling safe and unrestricted operation within or near the sterile field.

### SUMMARY

The present invention relates to a perioperative cobotic system configured with an external shell assembly that supports operation in sterile or semi-sterile surgical environments. The system includes a robotic base and one or more articulated robotic arms enclosed within a modular, sterilizable external shell. The shell comprises a plurality of articulating segments formed of sterilization-compatible materials such as medical-grade stainless steel, autoclavable polymers, or coated composites resistant to heat, chemical agents, or plasma-based sterilization processes.

Each shell segment is contoured to avoid seams, fasteners, or crevices that could harbor microbial contaminants. The shell includes sterility-preserving design features such as flush-mounted access panels, rounded edges, and fluid-resistant seals at articulation points. In various embodiments, the shell supports both reusable and disposable use cases, enabling rapid turnover between surgical procedures.

The shell assembly is modular and includes quick-release locking mechanisms and orientation guides that facilitate tool-free removal and reinstallation. Optional real-time sterility monitoring components such as surface contamination sensors, RFID tags, or color-changing indicators provide feedback regarding sterilization status or shell integrity. The shell is certified for operation within sterile zones without requiring sterile draping, and it may include transparent regions to permit visibility of internal displays or indicators.

Methods are also provided for maintaining sterility using the cobotic system, including pre-procedural sterilization, intraoperative operation within sterile fields, and post-procedural shell replacement or disinfection.

### BRIEF DESCRIPTION OF DRAWINGS

The foregoing and other objects, aspects, features, and advantages of the disclosure will become more apparent and better understood by referring to the following description taken in conjunction with the accompanying drawings, in which:

FIG. 1 is a perspective view of a perioperative cobotic system including a robotic base, articulated arms, and a segmented external shell configured to enclose and protect the system components.

FIG. 2 is a side view of the cobotic system of FIG. 1, illustrating the shell segments aligned with robotic joints and designed to accommodate articulation.

FIG. 3 is an exploded view of the shell assembly, showing the modular segments and associated quick-release locking mechanisms and orientation guides.

FIG. 4 is a schematic illustration of the system operating within a sterile field, highlighting flush-sealed access panels, fluid-resistant articulation seals, and sterile adapter ports.

FIG. 5 is a flow diagram of a method for maintaining sterility during surgical procedures using the cobotic system, including pre-use sterilization, intraoperative use, and post-use disassembly.

FIG. 6 is a block diagram illustrating the integration of real-time sterility monitoring components, including contamination sensors, camera systems, RFID-based tracking, and visual alert modules coupled to the shell segments.

These drawings are provided for illustrative purposes only and should not be construed as limiting the invention to the specific embodiments shown and described herein. Variations and modifications to these embodiments will be apparent to those skilled in the art, and all such variations and modifications are intended to be included within the scope of this disclosure.

### DETAILED DESCRIPTION

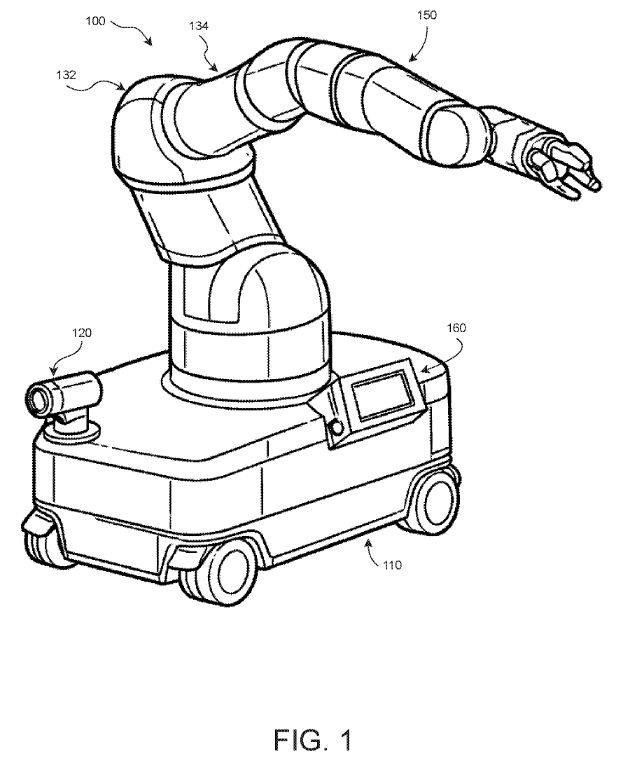

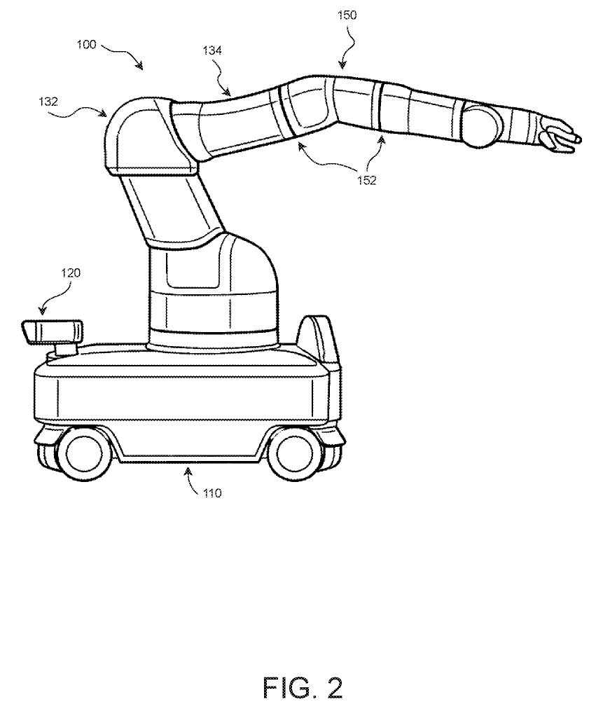

Referring to FIG. 1, a perioperative cobotic system 100 is illustrated in perspective view. The system 100 comprises a robotic cobot platform with a mobile base 110, one or more articulated robotic arms 150, and a segmented external shell assembly encasing the arms and portions of the base. The mobile base 110 provides stability and mobility (e.g., wheeled or tracked movement) to position the cobot in an operating room. Each robotic arm 150 includes multiple joints (e.g., shoulder, elbow, wrist for a humanoid form or serial joints for a robotic manipulator) that confer several degrees of freedom for surgical tasks. In the embodiment of FIG. 1, the external shell (shown in segments 132, 134, etc.) envelops the articulated limbs and relevant portions of the base, forming a continuous protective barrier around the cobot’s hardware. This shell can be either removable or integral to the robot’s structure, and is designed to be sterilizable or provided sterile, thereby allowing the entire system 100 to operate within a sterile surgical field without additional draping. By enclosing the robot in a sterilizable shell, the system avoids the need for conventional disposable drapes that are cumbersome, waste-intensive, and can hinder manipulation. The shell assembly is contoured to the robot’s form, with smooth outer surfaces and rounded edges that minimize any protrusions or gaps where microbes could reside. All exterior surfaces of the shell are non-porous and smoothly continuous, lacking exposed fasteners or recesses that could trap contaminants. This design not only reduces microbial harborage but also facilitates thorough cleaning and sterilization of the cobot’s exterior between uses. In some embodiments, the shell’s exterior may be coated or constructed with antimicrobial and high-durability materials to further suppress bioburden accumulation. The description that follows will explain the shell’s construction and operation in greater detail, with reference to FIGS. 2-6.

The perioperative cobot’s control and sensing components may be housed within the base 110 or arm structures, but they interface with the outside environment through the sterile shell. For instance, the system can include on-board imaging devices (e.g., a camera 120) and sensors that monitor the surgical environment or the shell’s integrity. These components are positioned behind transparent or otherwise accommodating portions of the shell (for example, a sealed optical window for a camera, not shown in FIG. 1) so that they can function without exposing any non-sterile surfaces. Optionally, a display 160 or status indicator can be integrated on the shell’s surface to provide visual feedback to staff (e.g., showing sterility status or system alerts), using a flush-mounted screen or panel that maintains the continuous sterile barrier. All such interfaces are designed to preserve sterility; for example, any control buttons or touch panels on the shell are covered by a sealed, flush membrane. The overall system 100 is thus designed for use in sterile zones, meaning it can be certified for direct presence at the surgical site without sterile drapes or covers beyond the shell itself. In use, prior to surgery the shell-enclosed cobot 100 is sterilized or donned with sterile shell components so that it can be positioned next to the operating table as needed, ready to perform tasks (whether assisting in surgery, instrument handling, or environmental monitoring) while maintaining the sterile field.

FIG. 2 is a side view of the cobot system 100 highlighting the alignment of shell segments with the robot’s joints. Each articulated arm 150 of the cobot is encased in a series of modular shell segments, for example, a shoulder segment 132, an upper-arm segment 134, a forearm segment, etc., such that the boundaries between shell segments coincide with the locations of the arm’s joints (rotational or prismatic axes). In the illustrated embodiment, annular joint covers or seals 152 are provided at each articulation point. These joint covers 152 may take the form of flexible bellows, O-ring seals, or overlapping lip interfaces between adjacent shell segments, and serve to maintain a continuous sterile barrier through the full range of motion of each joint. In one example, a shell segment 134 covering an upper arm overlaps slightly with the shell segment covering the forearm when the arm is extended; a compressible gasket or bellows 152 between them keeps the junction sealed as the arm bends or rotates. This design enables unhindered robotic motion at each joint while preventing any exchange of air, fluids, or microbes between the inside of the shell and the sterile exterior, even during dynamic movement. To achieve low-friction motion, the joint seals 152 are preferably made of materials like medical-grade silicone or flexible polymers that can withstand repeated flexing and sterilization cycles without degradation. These seals are engineered to provide at least an IP54-IP67 level ingress protection around each joint, meaning they block dust and resist fluid splashes or sprays from any angle. The ingress protection and smooth articulation ensure that no contamination can penetrate into the robot’s mechanisms, and likewise no internal grease or particulate from the robot will escape into the sterile field.

Each shell segment is custom-shaped to its underlying robot limb segment so as to minimize excess size and clearances. The interior of a shell segment has a clearance fit over the robot’s arm or joint housing, leaving just enough room for the arm to move freely within. The exterior of each segment is generally rounded or polygonal with filleted edges, avoiding any sharp corners. As shown in FIG. 2, the segments 132, 134, etc., meet at joints in a manner that maintains a substantially flush outer surface in all arm configurations. For example, the side view shows that when the arm bends at the “elbow” joint, the adjacent shell edges maintain close proximity without creating large gaps. This prevents any “accordion” folds or loose drape material that could snag or harbor contaminants, a significant improvement over loose sterile drapes. All exterior seams between shell segments are either sealed by the flexible joint covers 152 or are formed as overlapping labyrinth seals. In an overlapping configuration, one segment has a lip that nests under the edge of the adjacent segment throughout the motion range, with an internal gasket ensuring a fluid-tight seal. Such details are configured according to principles of hygienic design: smooth, non-porous surfaces, easy-to-sanitize geometries, and no exposed recesses or screw holes on the exterior. Fasteners, if used to connect shell pieces, are located internally or are of a type that leaves a flush exterior. In some embodiments, the shell segments are attached to the robot’s structure via internal brackets or clips, with only minimal, gasketed seams visible externally. This careful alignment and sealing strategy allows the robotic arm 150 to perform complex movements (rotations, extensions, etc.) while the sterile envelope remains intact at all times.

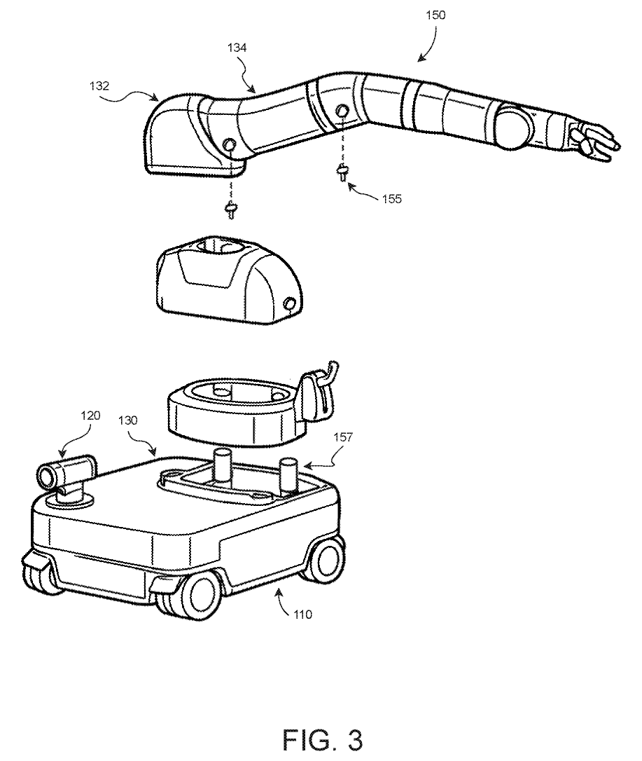

It should be noted that the shell design can accommodate both humanoid and non-humanoid cobotic architectures. In a humanoid configuration (see, e.g., FIG. 3 below), segments would correspond to anthropomorphic sections (upper arm, forearm, etc.), whereas in a more traditional robotic arm, the segments might be cylindrical or polyhedral covers for each link of the manipulator. In either case, FIG. 2’s principle holds: every joint or moving interface is protected by a correspondingly positioned shell segment and seal. By aligning shell segmentation with joint placement, the system avoids creating unsealed bending points, ensuring that even during motion, there are no breaches in the sterile barrier.

FIG. 3 provides an exploded assembly view of the external shell, illustrating how the modular shell segments interconnect and attach to form the complete protective shell around the cobot. In this view, the illustrated segments 172 (such as base cover 130, shoulder cover 132, upper arm cover 134, forearm cover, wrist cover, etc.), which collectively make up the shell assembly 170 when assembled, are shown separated from the robotic platform to reveal their structure and the means by which they join. Each segment 172 is designed as a removable module that can be attached or detached without tools, facilitating rapid assembly, disassembly, and interchange. For example, segment 134 may feature quick-release locking mechanisms 155 at its ends, these could be spring-loaded latch pins, quarter-turn twist locks, snap-fit clips, or magnetic couplers, that engage mating features on adjacent segments (or on the robot frame) to secure the segment in place during use. When a segment 172 needs to be removed (for cleaning, sterilization, or disposal), a technician can actuate the quick-release mechanism 155 (for instance, pressing a recessed latch or turning a knob a quarter turn) to unlock that segment from its neighbors, as depicted in FIG. 3. The orientation guides 157 on each segment ensure correct alignment during reassembly: these guides might be keyed protrusions and slots, color-coded markers, asymmetric shapes that make it obvious how the pieces fit together or rods that configured to mate with sleeves in adjacent segments. Such features reduce the chance of assembly error, a segment can only mount in the proper orientation, aligning the built-in seals and connectors correctly. In FIG. 3, each shell module is also shown with its integrated seal (e.g., an O-ring or gasket running around the perimeter of the mating flange). When assembled, these seals are compressed between segments to form airtight junctions. Locking clamps or latch points 155 are spaced around the circumference of each segment interface, providing even sealing pressure and robust mechanical attachment.

The exploded view of FIG. 3 also highlights the modularity and interchangeability of the shell system. In some embodiments, the shell modules are standardized so that they can be swapped out or replaced independently. For example, if one segment becomes damaged or heavily soiled, it can be removed and replaced with a spare segment without replacing the entire shell. This modular approach also supports different embodiments of shell material and reusability. One embodiment is a reusable, sterilizable shell: here, each segment is made of a durable material (such as a high-performance polymer or composite) that can withstand repeated sterilization cycles. For instance, segments may be molded from polycarbonate, polypropylene, PPSU (polyphenylsulfone), or anodized aluminum, all of which can endure autoclave steam sterilization at 121-134 °C, as well as other methods like hydrogen peroxide plasma or ethylene oxide gas. These reusable segments are designed for longevity, possibly featuring slightly thicker walls or reinforced structures to resist warping or wear over time. They may have textured grip areas or tabs (still external-smooth but slightly raised) to assist staff in handling them with gloved hands during assembly/disassembly. In contrast, another embodiment uses single-use (disposable) shell segments. These could be formed of lighter-weight, cost-effective materials (for example, thin thermoformed PE or PVC plastic, or disposable biopolymer composites) and come pre-sterilized in packaging. Before a procedure, staff would unpackage the sterile disposable shell pieces and snap them onto the robot; after the procedure, the pieces are safely discarded. Disposable segments offer the advantage of zero reprocessing time, a fresh sterile barrier is provided for each case, and eliminate any risk of degradation from repeated sterilization. They also might incorporate simpler integral fastening features (like peel-and-stick adhesive strips or single-use clips) to attach to the robot quickly. However, disposables create more medical waste; accordingly, the design leaves it to the user’s preference or clinical needs whether to use reusable or one-time shell components.

Notably, the shell assembly is compatible with multiple sterilization modalities to accommodate different hospital practices. For reusable embodiments, the materials and construction are chosen to be robust against moist heat (steam autoclaving), dry heat, chemical sterilants, plasma sterilization (vaporized hydrogen peroxide), and UV-C irradiation, among others. For example, a silicone elastomer gasket used in the shell’s seals is selected for high thermal stability and chemical resistance so that it remains elastic after autoclaving and does not degrade with hydrogen peroxide exposure. Likewise, any plastics are of medical grade and stabilized against radiation if gamma or e-beam sterilization is used (especially relevant for pre-sterilized disposable sets). By designing the shell for broad sterilization compatibility, the system can be integrated into existing hospital sterile processing workflows, whether that means a quick turnaround steam sterilization between back-to-back surgeries or using low-temperature methods to avoid heating sensitive electronics. The quick-release modular design shown in FIG. 3 is central to enabling fast turnover: after a surgery, staff can unlatch and remove all soiled shell segments in a matter of minutes, either sending them for reprocessing or disposing of them, and then install either the same reprocessed segments or a fresh set onto the cobot before the next procedure. The intuitive orientation guides and tool-free latches ensure that this process is straightforward and does not require specialized tools or extensive training.

In summary, FIG. 3 depicts how the external shell is constructed in segments for ease of disassembly, cleaning, and replacement, supporting both reusable and single-use embodiments. This modular shell assembly provides a robust yet flexible solution for maintaining a sterile robot exterior: it can be rapidly taken apart for sterilization or part replacement, then reassembled correctly every time, thereby supporting the claims of tool-free disassembly, modularity, and multi-modal sterilization compatibility.

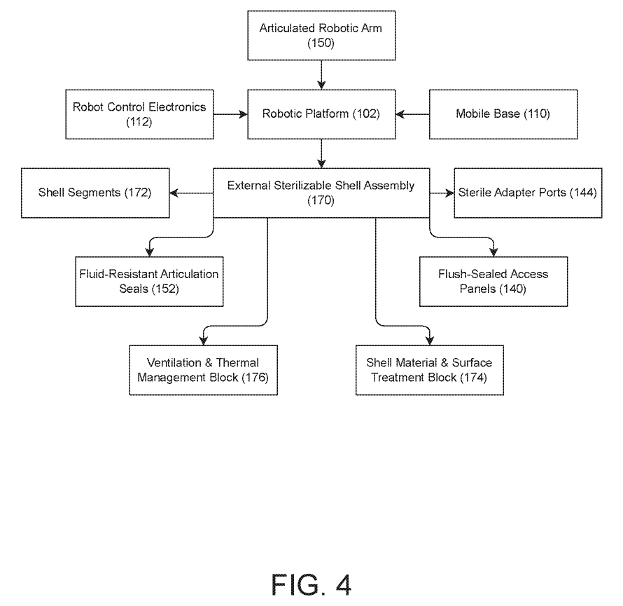

FIG. 4 is a block diagram illustrating a sterility-preserving architecture of a perioperative cobotic system 100, showing functional subsystems and interfaces that collectively enable operation within a sterile surgical field without external draping. The diagram depicts interactions among a robotic platform 102, an external sterilizable shell assembly 170, and multiple sterility-supporting subsystems that maintain a continuous sterile barrier during operation.

The robotic platform 102 includes a mobile base 110, one or more articulated robotic arms 150, and internal robot control electronics 112. These components are physically enclosed and functionally isolated from the sterile field by the external shell assembly 170, which forms a continuous barrier between internal non-sterile components and the external sterile environment.

The external shell assembly 170 comprises a plurality of sterility-preserving structural and interface blocks, including shell segments 172, flush-sealed access panels 140, fluid-resistant articulation seals 152, and one or more sterile adapter ports 144. The shell segments 172 are mechanically aligned with joints of the articulated robotic arm 150 and are configured to maintain coverage throughout the full range of motion.

The flush-sealed access panel block 140 provides controlled access to internal subsystems such as a power module, battery module, and/or internal electronics, while preserving sterility when closed. Each access panel 140 includes a sealing interface 142 (e.g., gasket, O-ring, or membrane seal) and a panel locking mechanism 143 (e.g., quarter-turn latch or magnetic coupler) configured to maintain a fluid-tight and microbiologically sealed boundary. In the block diagram, access panels 140 are shown as sterility-controlled interfaces between the shell assembly 170 and internal serviceable components.

The sterile adapter port block 144 represents one or more sealed pass-through interfaces that permit transfer of power, data, tools, or auxiliary devices across the shell boundary without breaching sterility. Each sterile adapter port 144 includes a sealed coupling interface 145 and an optional valve or cap 146 that remains closed when the port is not engaged. In some embodiments, sterile adapter ports 144 are coupled to an end-effector interface 151 at a distal end of the robotic arm 150, or to auxiliary subsystem interfaces 118 located on the base 110.

The fluid-resistant articulation seal block 152 is positioned at each joint interface of the articulated robotic arm 150 and functions as a dynamic sterility barrier during motion. As shown in the block diagram, each articulation seal 152 mechanically couples adjacent shell segments 172 while preventing ingress of liquids, particulates, or contaminants. These seals may include labyrinth geometries, multi-flange structures, or compliant elastomeric materials that maintain sealing integrity during articulation.

The block diagram further illustrates a shell material and surface treatment block 174, representing material properties of the shell assembly 170, including smooth, non-porous exterior surfaces, optional antimicrobial coatings, and finishes compatible with chemical, thermal, or ultraviolet sterilization processes. This block emphasizes that sterility preservation is achieved through material selection and geometry, rather than disposable draping.

In some embodiments, FIG. 4 further includes a ventilation and thermal management block 176, which represents filtered vents, sealed heat exchangers, or fanless cooling structures that permit thermal regulation of internal components while maintaining sterility. Where present, ventilation pathways are routed through sterile filtration elements 177 or are positioned outside defined sterile zones.

Collectively, the blocks shown in FIG. 4 define a sterility-preserving system architecture in which the perioperative cobotic system 100 operates as a certified sterile apparatus. The external shell assembly 170 functions as the primary sterile barrier, while access panels 140, adapter ports 144, articulation seals 152, and material properties 174 cooperate to maintain sterility throughout robotic motion, tool exchange, power/data interfacing, and extended surgical use.

Accordingly, FIG. 4 demonstrates a system-level sterility architecture that enables the cobotic system 100 to be positioned and operated within a sterile surgical field without the use of disposable drapes, while supporting internal servicing, external interfacing, and unrestricted robotic articulation in compliance with surgical sterility requirements.

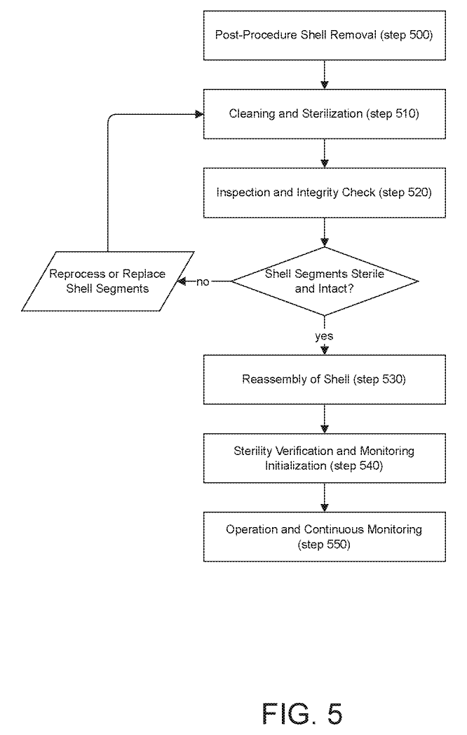

FIG. 5 illustrates a flow diagram of a process for maintaining and verifying sterility of a perioperative cobotic system during turnover between surgical procedures. The process leverages a modular external shell, sterilization-compatible materials, and automated verification mechanisms to ensure the cobot is sterile and ready for each subsequent surgery. Each step shown in FIG. 5 corresponds to a block in the flow diagram and is described below.

Post-Procedure Shell Removal (step 500). Immediately after completion of a surgical procedure, external shell segments of the cobotic system are removed or opened, depending on whether the shell is reusable or disposable. Personnel disengage the shell segments from the robotic base and articulated arms using integrated quick-release locking mechanisms, allowing tool-free removal. In disposable embodiments, the shell segments are detached and discarded as regulated medical waste. In reusable embodiments, the shell segments are placed into designated containers for transport to sterile processing. Portions of the cobot not exposed to the sterile field may remain covered, but in many workflows all exterior shell components are treated as contaminated to reduce risk.

Cleaning and Sterilization (step 510). Reusable shell segments are subjected to a validated sterilization process selected based on material composition and embedded component compatibility. Sterilization modalities may include steam autoclaving, hydrogen peroxide plasma, ethylene oxide gas, ultraviolet-C irradiation, or approved chemical disinfectants. Shell materials and seals are selected to withstand repeated sterilization cycles without degradation. In disposable shell embodiments, pre-sterilized replacement segments are prepared for use. During this step, underlying robotic structures may optionally be wiped down or disinfected as a precautionary measure, even though they remain isolated from the sterile field.

Inspection and Integrity Check (step 520). Following sterilization or preparation of new sterile shell components, each shell segment undergoes an integrity inspection. This inspection includes verification that seals are intact, locking mechanisms function properly, and no visible residue or damage is present. In some embodiments, shell segments include RFID tags that store component identifiers and sterilization metadata. The cobot’s control system scans these identifiers to confirm sterilization status, usage history, and compatibility. Automated verification reduces assembly errors and ensures that only approved sterile shell components are used.

Reassembly of Shell (step 530). Sterile shell segments are reattached to the cobotic system to reconstitute the external sterile barrier. Orientation guides ensure correct alignment of shell segments relative to robotic joints and interfaces. Locking mechanisms provide tactile, audible, or electronic confirmation of proper engagement. During reassembly, the control system may monitor RFID tag detection, alignment sensors, or latch status indicators to verify that all shell components are present and properly secured before operation.

Sterility Verification and Monitoring Initialization (step 540). After reassembly, the system performs an automated sterility verification sequence. The control system confirms that all shell segment identifiers are detected and validated, seal integrity is within acceptable thresholds, and no contamination indicators are present. Diagnostic checks may include pressure tests, particle sensing, or surface contamination scans. Upon successful verification, the system generates a “sterile-ready” status via a local display or networked interface. If a fault is detected, alerts are generated to prevent entry into the sterile field.

Operation and Continuous Monitoring (step 550). During the subsequent surgical procedure, the cobotic system continuously monitors sterility conditions in real time. Sensor data is evaluated to detect shell displacement, seal failure, contamination events, or unauthorized access. If a sterility risk is identified, the system may issue alerts, restrict motion, or initiate a controlled withdrawal from the sterile field. Upon completion of the procedure, the process returns to Post-Procedure Shell Removal (step 500) for the next turnover cycle.

By executing the process shown in FIG. 5, the perioperative cobotic system maintains a validated sterile condition across successive surgical procedures. The flow diagram demonstrates how modular shell construction, compatibility with multiple sterilization modalities, and automated verification mechanisms collectively reduce turnover time, minimize human error, and provide traceable sterility assurance in compliance with operating room protocols.

Accordingly, FIG. 5 illustrates a repeatable sterility management workflow that enables the cobot to be processed similarly to conventional surgical instruments—removal, sterilization or replacement, reassembly, verification, and reuse—without the need for disposable draping or prolonged manual preparation.

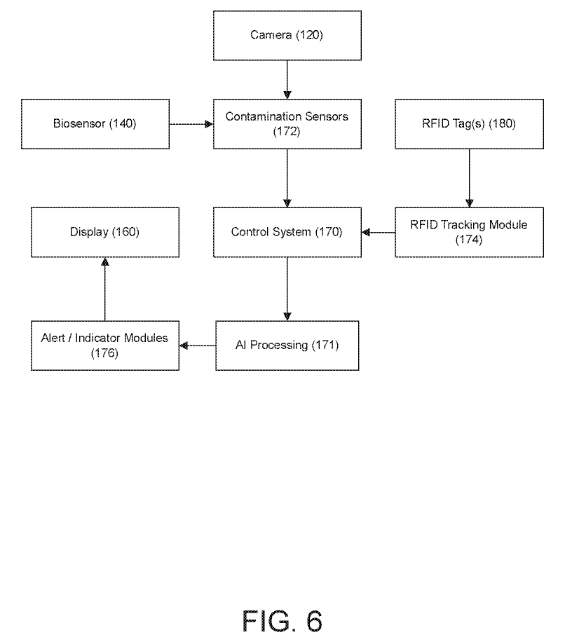

FIG. 6 is a block diagram depicting the integration of sterility monitoring components in the perioperative cobotic system, including contamination sensors, RFID tracking, and alert/indicator modules, all coordinated by the control system and optional AI software. This intelligent sterility monitoring system complements the physical shell by actively supervising the sterile status of the cobot in real-time and over its usage life.

In the diagram of FIG. 6, multiple sensor inputs feed into the cobot’s central control system 170 (which may include one or more processors, memory, and interfaces running specialized software). Key components include:

Contamination Sensors 172: These may comprise a variety of sensing modalities to detect breaches of sterility or presence of contaminants on the shell. For example, an optical sensor or camera (like the camera 120 mentioned earlier) can capture image data of the shell’s surface and surrounding area. Using computer vision, the system’s AI can analyze these images for signs of contamination, such as fluid spots, dirt, or biological material on the shell, or for events like an unplanned contact with a non-sterile object. In one embodiment, the camera might use ultraviolet or fluorescence imaging to highlight biological residues (a technique where a fluorescing agent is applied and any organic residue glows, allowing the system to spot it). Another contamination sensor could be a biosensor 140 mounted on the robotic arm (as described in the earlier figures): this sensor can be deployed to take direct measurements of bioburden on surfaces. For instance, if the vision system identifies a “high-risk local region” on the shell or an OR surface (e.g., a spot that might have gotten splashed), the robot can autonomously move the biosensor 140 to that location to assess microbial load. FIG. 6 conceptually shows steps like capture image data, identify high-risk region, move to region, assess bioburden, and generate data as part of this closed-loop monitoring. These contamination sensors thus provide continuous or periodic data that the system evaluates to ensure the shell and the environment immediately around it remain sterile during use.

RFID Tracking Module 174: As noted in FIG. 5, RFID tags are embedded in shell segments and potentially in other components (like surgical instruments the robot handles). The RFID module 174 in FIG. 6 represents the reader hardware and associated logic that communicates with these tags. It keeps an inventory of which shell pieces are currently attached and confirms their sterilization status. The control system cross-references this with an internal database or cloud service, effectively creating a real-time log of the robot’s sterile configuration. This can also track usage counts (e.g., how many times a particular reusable shell segment has been sterilized and used, useful for knowing when to retire and replace it due to wear). The RFID module may operate continuously or at key times (such as upon shell reassembly, or periodically during operation to ensure no segment has become detached). Because RFID does not require line-of-sight, the system can poll all tags even with the shell assembled, allowing it to detect if, say, a segment were missing or if an extra unrecognized piece was attached.

Control System & AI Processing 170: At the heart is the control system (which can be an embedded computer on the robot). It receives data from the contamination sensors 172 and RFID module 174, and it runs algorithms, potentially machine learning models, to interpret this data. The AI component can be trained to distinguish between true contamination and false positives (for example, a drop of betadine vs. a harmless reflection in the camera view), and to predict potential contamination events. As an example, by analyzing patterns (like the areas of the shell that frequently get splattered or touched), the AI could predict where and when the highest contamination risks occur, and proactively direct the robot or alert staff to mitigate those risks. The control system also integrates with the robot’s operational functions; if a serious sterility breach is detected, it might trigger a certain action, e.g., pausing the robot’s activity, moving it away from the sterile field, or shutting down non-essential functions, until the issue is resolved. The AI may further use historical turnover data to refine sterilization cycles or maintenance schedules (for example, learning that after X hours of operation, certain seals might start to fatigue and advising replacement at optimal intervals, thereby preventing a failure that could compromise sterility). All sensor readings, decisions, and actions can be logged by the control system for quality assurance and regulatory compliance records.

Alert/Indicator Modules 176: These modules represent the outputs that communicate the system’s status to human operators. FIG. 6 includes, for instance, an alert generator that can produce visual alerts (such as flashing LEDs or on-screen messages on display 160) and audible alarms if needed. For everyday operation, the system might have a simple sterility status indicator, e.g., a green light meaning “Sterile: all systems go”, and a red light or notification if any anomaly is found (like a segment not fully locked or a sensor detecting contamination). The system could also integrate with hospital networks: sending a message to a central dashboard or to the biomedical engineering team if something needs attention (e.g., “Arm shell segment 3 needs replacement after this case”). In one embodiment, the display 160 on the robot can show a real-time “sterility score” or contamination map, highlighting any areas of concern, which is derived from the sensor data. This gives surgical staff immediate feedback, for example, if the robot’s arm accidentally touches a non-sterile object, the system could alert the team to regown that part or re-sterilize on the spot with a sterile wipe, etc. The alert module thus helps ensure that any potential contamination is addressed instantaneously, maintaining safety.

The block diagram of FIG. 6 shows these components working in concert as an integrated sterility assurance system. For instance, a possible sequence (mirroring the flow chart logic): (a) The camera captures an image and the AI identifies a possible contaminant on the shell, (b) the robot moves its base or arm to position the biosensor and confirms the contaminant (assessing bioburden level), (c) the system logs the data and triggers an alert if threshold exceeded, possibly prompting a pause for a quick cleaning, and (d) it updates the display with aggregated contamination data or a timestamped record. Simultaneously, the RFID system might note that one shell panel was opened (if it had a sensor) and not properly closed, prompting an alert to secure it. All these actions are orchestrated by the control system’s software.

Overall, FIG. 6 underscores that the invention is not only a passive protective shell but also an active monitoring solution. This supports the claims of real-time sterility tracking using sensors and indicators: the combination of vision/biosensors for contamination detection and RFID for component tracking, supervised by intelligent algorithms, ensures that sterility is maintained and any deviation is immediately flagged. Importantly, these systems are designed to be robust in the OR environment, the sensors are either protected by the shell or form part of it, and the computing is done on secured hardware in the base 110 (or offloaded to a hospital server if needed), all without introducing any non-sterile elements. By including AI-driven monitoring, the cobot can achieve a level of vigilance that complements human awareness, potentially catching issues that staff might miss and providing an additional layer of safety. This integration of hardware and software for sterility management is a novel aspect of the perioperative cobotic system, as it transforms what used to be a purely manual checklist-based process (ensuring something is sterile) into a continuously verified and logged process by the machine itself.

Adaptation to Various Cobot Architectures (Humanoid vs. Non-Humanoid)

The principles of the sterilizable external shell described above are applicable to a range of cobotic architectures, including both humanoid-form robots and more traditional robotic arm platforms. The Detailed Description thus far has generally depicted a cart-mounted robotic arm system, but FIG. 3 (for example) could also represent a humanoid perioperative cobot. In a humanoid cobot embodiment, the robot might have a torso, two arms, a head, and possibly wheeled or bipedal locomotion. In such a case, the sterilizable shell can take the form of a full-body sterile suit for the robot. For instance, the torso and limb sections of a humanoid could be covered by tailored shell garments or rigid/flexible segments analogous to those described, but shaped to human-like anatomy. The design may leverage aspects of how humans maintain sterility: the humanoid robot could literally don sterile apparel. One envisioned embodiment uses a combination of rigid shell pieces and sterile wearable covers, e.g., a rigid exoskeletal shell on the torso and joints, combined with sterile sleeves or gowns that drape over the shell. The humanoid’s arms might be inserted into sterile sleeve covers with integrated gloves, much like a surgeon wears a gown and gloves. These sleeves could attach via quick-connect rings at the shoulder, ensuring they stay in place and taut (similar to how sterile surgical gowns attach to a helmet system in some cases). The robot’s “hands” (end-effectors) could be covered by oversized sterile gloves that lock onto the wrist shell segments, providing both dexterity and sterility. A helmet or hood could cover the robot’s head, potentially with a transparent visor for any cameras in the head to see through (the visor being part of the sterile barrier). In fact, some embodiments might simply use standard sterilizable fabrics and garments adapted for the robot, since a humanoid shape is amenable to existing sterile clothing, the invention can encompass the robot effectively “wearing” a sterile gown and head cover over an internal shell frame. The external shell in that case might be a combination of fabric and rigid components, all sterilizable or disposable. The design rationale for a humanoid is that it can then safely operate in a manner similar to a human in the OR, for example, standing over the sterile field to assist, or manipulating instruments, without risk of contamination, because it’s dressed in a sterile barrier.

For non-humanoid architectures (e.g., a robotic arm on a cart, or a ceiling-mounted surgical robot), the shell design may be more strictly modular rigid segments as we have detailed. A ceiling-mounted arm, for instance, could have clam-shell halves that enclose each link of the arm, since weight is less of a concern when mounted. A mobile base unit like in FIG. 1 may be covered on its top surface by a shell lid and on its sides by detachable panels, leaving wheels or locomotion elements either outside the sterile field or made of sterilizable material if they must enter it. The system can be configured such that only the portions of the cobot that extend into or above the sterile field are fully encased, while other portions remain outside. For example, the base 110 might stay outside the sterile boundary (at the periphery of the room) with only the upper arms reaching in; in that scenario, the base could either be undraped (if sufficiently distant) or have its own less extensive shell. The versatility of the shell system allows adaptation: whether the robot has one arm or four, whether it’s anthropomorphic or purely industrial in form, each limb or appendage that needs to be sterile can be given a corresponding set of shell segments, seals, and sterile adapters as described.

It is also contemplated that the shell can incorporate form-factor-specific design elements. In a humanoid, for instance, the shell may have an intentionally human-like outer appearance (perhaps to make the staff comfortable and the robot approachable), essentially simulating a sterile-suited person. In a non-humanoid, the shell might prioritize compactness around mechanical joints and could be more cylindrical or faceted. In either case, the underlying sterile design principles remain consistent: smooth, easily sterilized surfaces, reliable seals at moving joints, modular sections for removal, and integrated sterility monitoring. The internal components (motors, sensors, etc.) may differ between a humanoid and an articulated arm, but both are equally protected by the external shell barrier. The Detailed Description’s focus on one configuration is not limiting; rather, the invention encompasses any collaborative robot architecture equipped with the described sterilizable or disposable shell system to enable safe perioperative use.

In conclusion, the perioperative cobotic system with a sterilizable external shell provides a comprehensive solution for using robots in sterile surgical environments. Through the detailed embodiments above, we have shown how the system includes hardware features (a multi-jointed cobot enclosed in a modular, sterilizable shell with sealed joints, flush panels, and adapter ports) and optional software/AI features (sensors, RFID, and AI-driven monitoring) that together maintain sterility and support surgical workflows. The description supports the various claimed aspects: the removable or integral shell that encloses articulated limbs, formed of sterilizable or disposable material and shaped to minimize microbial harborage; the quick-release modular construction for easy disassembly; compatibility with sterilization modalities from autoclave to UV-C; design features like smooth surfaces, sealed panels, fluid-resistant seals to maintain sterility; real-time tracking of sterility via sensors and indicators; and the ability to operate in sterile zones without additional draping, whether the robot is humanoid or not. With sufficient detail provided, a person of ordinary skill in the art can implement the invention in various forms (humanoid, arm-type, etc.) and understand the specific structures (locks, seals, materials, electronics) that enable the cobot to function as a sterile, reusable surgical assistant. The combination of structural innovation and intelligent monitoring in this system marks a significant step forward in surgical robotics, marrying the precision and strength of robots with the stringent sterility requirements of the operating room.

While specific embodiments have been described to enable practice of the disclosed subject matter, they are illustrative and not limiting. Variations, modifications, substitutions, and combinations of the features described can be made by those skilled in the art without departing from the scope of this disclosure. Features described with respect to one embodiment may be used with, or substituted for, features of another. Unless expressly stated otherwise, the terms “comprising,” “including,” and “having” are used in an open, non‑limiting sense; the singular forms “a,” “an,” and “the” include the plural forms; and stated ranges include their endpoints and all subranges. Unless the context clearly indicates otherwise, “and/or” means one or more of the listed items (e.g., “A and/or B” encompasses A alone, B alone, or both A and B); “or” is inclusive (i.e., “A or B” means A, B, or both); and “and” is conjunctive. Headings and ordering are for convenience and do not limit the description. The scope of the claimed subject matter is defined solely by the claims that follow and their legal equivalents.

What is claimed is:

1. A perioperative cobotic system, comprising:
a robotic base;
at least one articulated robotic arm mounted on the robotic base; and
an external shell enclosing the at least one articulated robotic arm and at least a portion of the robotic base, the external shell comprising a plurality of segments movably connected to one another to accommodate movement of the at least one robotic arm, wherein the external shell is made of a sterilization-resistant material and has smooth, non-porous surfaces configured to prevent microbial harborage and maintain sterility during perioperative use.

2. The system of claim 1, wherein the segments of the external shell are shaped to maintain a full range of motion of the at least one articulated robotic arm while minimizing particulate generation and microbial harborage.

3. The system of claim 1, wherein the external shell is fabricated from a material suitable for repeated sterilization cycles, the material being selected from the group consisting of medical-grade stainless steel, an autoclavable polymer, and a high-temperature-resistant coated composite, and combinations thereof.

4. The system of claim 1, wherein the external shell has a smooth, non-porous contoured surface substantially free of seams, fasteners, or joints that could harbor contaminants.

5. The system of claim 1, wherein the external shell includes flush-sealed access panels and rounded edges to eliminate crevices and sharp corners that could trap contaminants.

6. The system of claim 1, wherein the external shell further comprises fluid-resistant seals at articulation points to prevent fluid ingress and contamination during cleaning or sterilization.

7. The system of claim 1, wherein the external shell is configured to support in situ disinfection between surgical procedures by accommodating cleaning with at least one of disinfectant wipes, chemical sprays, or ultraviolet-C light.

8. The system of claim 1, wherein the external shell is constructed to allow the cobotic system to operate within a sterile surgical field without requiring a sterile drape or cover.

9. The system of claim 1, further comprising at least one sterile adapter port integrated into the external shell for surgical instrument handoff or tool docking while maintaining a sterile barrier.

10. The system of claim 1, wherein the external shell comprises a modular assembly of shell sections that are detachably mounted on the cobotic system, each shell section including a quick-release locking mechanism and an orientation guide to enable tool-free removal and reattachment of the section without affecting operation of the cobot.

11. A sterilizable external shell assembly for a perioperative robotic system, the shell assembly comprising:
a plurality of articulating shell segments configured to enclose at least one robotic arm and a portion of a robotic base of the robotic system, the shell segments being movably interconnected so as to accommodate full articulation of the robotic arm without impeding its motion, wherein:
the shell segments are formed of a material resistant to repeated sterilization processes,
and each shell segment has a smooth, non-porous exterior surface substantially free of seams or joints that could harbor microbial contaminants.

12. The shell assembly of claim 11, wherein the shell segments are detachably secured to the robotic system by quick-release locking mechanisms and alignment guides, thereby allowing removal and reassembly of the shell segments without tools.

13. The shell assembly of claim 11, further comprising one or more sterility monitoring components selected from the group consisting of surface contamination sensors, RFID-based sterilization tracking tags, and color-changing sterilization indicators.

14. The shell assembly of claim 11, wherein the shell assembly is configured to provide an alert if any shell segment is not properly secured, if a predetermined sterilization interval has elapsed since a last sterilization, or if the shell assembly has been removed from a sterile area without prior disinfection.

15. The shell assembly of claim 11, wherein the shell segments are configured to be sterilized for reuse or alternatively provided as single-use disposable sterile covers for the robotic system.

16. The shell assembly of claim 11, wherein at least a portion of the shell assembly is transparent to permit viewing of an internal display or indicator of the robotic system through the shell while maintaining a sterile enclosure.

17. A method of maintaining sterility during a surgical procedure using a perioperative cobotic system, the method comprising:
covering at least one robotic arm and a robotic base of the cobotic system with an external shell assembly that has been sterilized, the external shell assembly having a smooth, non-porous surface, thereby establishing a sterile barrier around the cobotic system;
positioning the cobotic system within a sterile surgical field and operating the cobotic system without placing a sterile drape over the cobotic system; and
after completion of the surgical procedure, removing the external shell assembly from the cobotic system for sterilization or replacement before a subsequent procedure.

18. The method of claim 17, further comprising sterilizing the external shell assembly prior to the surgical procedure by subjecting the shell assembly to an autoclave cycle to ensure the shell assembly is sterile.

19. The method of claim 17, further comprising monitoring a sterility status of the external shell assembly during the surgical procedure using at least one contamination sensor or sterilization indicator on the cobotic system, and generating an alert in response to detection of a contamination event or an improperly attached shell segment.

20. The method of claim 17, wherein removing the external shell assembly after the procedure comprises detaching one or more of the shell segments and performing at least one of sterilizing the detached shell segments for reuse or discarding the detached shell segments as disposable components.
